(19) United States
(12) Patent Application Publication
(10) Pub. No.: US 2005/0010530 A1
(43) Pub. Date: Jan. 13, 2005

(54) Copyright management system

(75) Inventors: Masaki Kakutani, Tokyo (JP); Shunichi Kumakura, Tokyo (JP); Motoaki Aoyama, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Minolta Business Technologies, Inc., Tokyo (JP)

(21) Appl. No.: 10/827,927

(22) Filed: Apr. 19, 2004

(30) Foreign Application Priority Data
Jul. 8, 2003 (JP) 2003-193618

(51) Int. Cl. G06F 17/60

(52) U.S. Cl. 705/57

(57) ABSTRACT

An copyright management system comprises a copier for copying an original and/or data, a copyright database for storing copyright management information having information indicating a permissibility of copying the original and/or data, and a copyright management server for sending in response to an inputted sending request the copyright management information to a requesting source, those being connected to each other through a network, wherein the copier obtains an identification code for identifying the original and/or data from an RFID embedded therein, sends an obtained identification code to the copyright management server, requests the copyright management server to send the copyright management information associated with the original and/or data thereof, and determines the permissibility of copying the original and/or data of the identification code included in the copyright management information based on the copyright management information sent from the copyright management server in response to the sending request.

### BACKGROUND OF THE INVENTION

1. Field of the Invention

The present invention relates to a copyright management system for protecting the copyright on publication, data and the like.

2. Description of Related Art

Various technologies have been proposed in the past for protecting copyright on publication, data (for example, program data) and the like. For instance, patent document 1 (JP Tokukaihei 7-110645) discloses a technology to manage copying of a literary work in which a copier reads a bar code from an original image, the barcode data is sent to a management apparatus through a communication network, and the management apparatus determines a permissibility of copying and calculates a royalty. Further, Patent document 2 (JP Tokukai 2002-209039) discloses another technology to control copying of a book in which a copier reads by a sub-scanner an identification code (bar code) such as ISBN and ISSN printed on the back of the book, and also obtains a corresponding copy-condition information from a database through a communication network, determines a permissibility of copying and calculates a royalty.

However, the technologies of earlier development described above cause a problem: in case the copyright or the like is managed based on an identifier such as a bar code visually recognized with ease, copying can be unfairly performed free from copyright when a trick is played on the bar code, to thereby disable the management of the copyright.

### SUMMARY OF THE INVENTION

An object of the present invention is to provide a copyright management system capable of securely protecting copyright by preventing publications and/or data from being unfairly reprinted or copied.

To solve the above problem, in accordance with an aspect of the present invention, an copyright management system comprises a copier for copying an original and/or data, a copyright database for storing copyright management information having information indicating a permissibility of copying the original and/or data, and a copyright management server for sending the copyright management information to a requesting source in response to an inputted sending request, the copier, the copyright database and the copyright management server being connected to each other through a network,
wherein the copier comprises an identification code obtaining section for obtaining an identification code for identifying the original and/or data from a radio frequency tag embedded into the original and/or data, and a control section for sending the obtained identification code to the copyright management server, requesting the copyright management server to send the copyright management information associated with the original and/or data of the identification code, and determining the permissibility of copying the original and/or data of the identification code included in the copyright management information based on the copyright management information sent from the copyright management server in response to the sending request, and
wherein when the identification code is received from the copier, the copyright management server obtains the copyright management information associated with the original and/or data of the received identification code from the copyright database, and sends the obtained copyright management information to the copier.

Further, it is preferable that the copyright management information comprises information indicating a royalty for each original and/or data to be paid at each time of copying.

Further, the copier may comprise a display section for displaying a part of or whole copyright management information received from the copyright management server.

Further, a copy history database for storing copying history information representing a copying history for each original and/or data may be connected to the network,
when copying is performed, the control section may send a copy completion notice information having information of finishing the copying and the identification code of a copied original and/or data to the copyright management server, and the copyright management server may update the copying history information for the original and/or data of the identification code included in a sent copy completion notice information out of the copying history information recorded in the copy history database based on the copying history information.

Further, in case a user ID for identifying an operator of a copy operation is inputted at the time of the copying, the control section may send the inputted user ID and the copy completion notice information to the copyright management server, and the copyright management server may make the copying history information for the original and/or data of the identification code included in the sent copy completion notice information associated with the sent user ID, out of the copying history information recorded in the copy history database, and update the copying history information based on the copying history information.

Further, the copyright management server may add up the royalty at predetermined periods for each identification code or each user ID in the copying history information recorded in the copy history database, and send an added-up value of the royalty to the requesting source in response to the inputted sending request.

By use of the present invention, based on the identification code of the original and/or data to be copied, there can be easily obtained the information on whether copying of the original and/or data is permitted, and on how much royalty is to be charged in case copying is permitted. Therefore, the copying of original and/or data that is not allowed is not copied, and in case copying of original and/or data is allowed, the royalty can be securely collected in exchange for payment of the royalty, leading to secure protection of copyright.

Further, since the copyright management server collectively manages the copyright management information, setting of copy permissibility, royalty and the like can be changed easily and rapidly.

As for a secret or an important document produced in a company or the like, the copy permissibility thereof can be set for each user (for example, employee or the like), to thereby achieve flexible and precise copyright protection.

In other words, prevention of publication and/or data or the like from unfair reprint or copy enables secure protection of their copyright.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a view showing a configuration of a copyright management system according to the present invention;

FIG. 2 is a table showing an example of copyright management information recorded in a copyright database shown in FIG. 1;

FIG. 3 is a table showing an example of copying history information recorded in a copy history database shown in FIG. 1;

FIG. 4 is a block diagram showing the internal structure of a copier shown in FIG. 1;

FIG. 5 is a table showing an example of user information recorded in a user ID database shown in FIG. 4;

FIG. 6 is a view showing a schematic structure of an original reading part provided on an image reading section shown in FIG. 4;

FIG. 7 is a flow chart explaining a copy process executed by the copier shown in FIG. 1; and

FIG. 8 is a flow chart explaining a copyright management process executed by a copyright management server shown in FIG. 1.

### DETAILED DESCRIPTION OF THE PREFERRED EMBODIMENTS

A detailed description will be given of a copyright management system 100 according to the present invention with reference to the accompanying drawings.

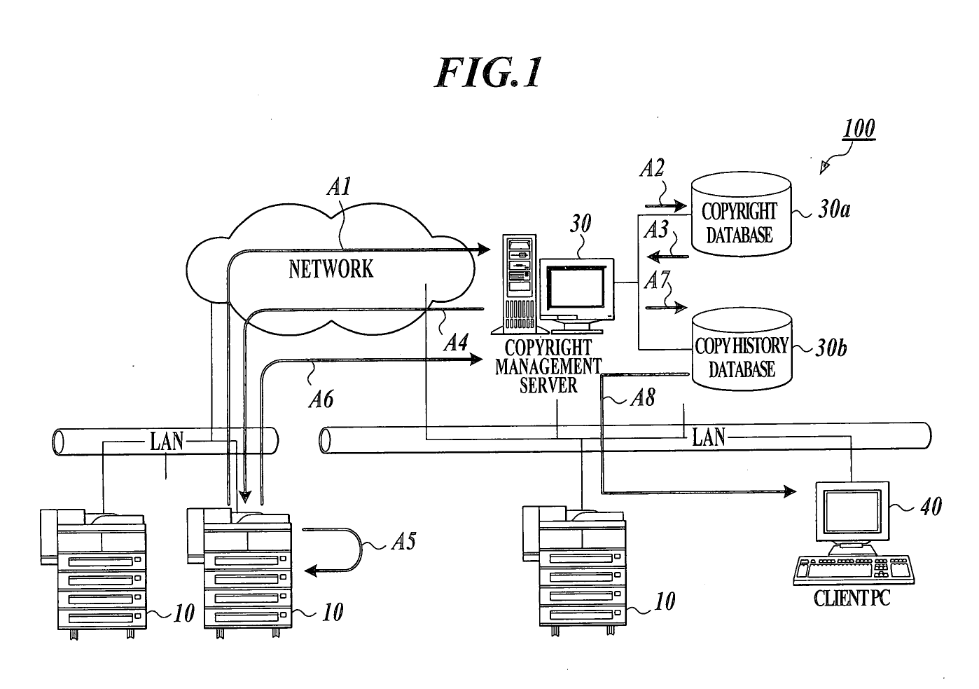

Referring to FIG. 1, the copyright management system 100 has a plurality of copiers 10 connected to each other through a LAN (Local Area Network) and a copyright management server 30, and these are connected to each other through a network.

The copier 10 is a multifunction machine having functions of printing, copying, scanning, communicating and the like. When an image is read from an original with use of copying or scanning function (hereinafter, a general term “copy” is used for reading an image from an original), the copier 10 reads from the original an identification code particular to each original, inquires of the copyright management server 30 whether the original is permissible to be copied, that is, whether it is permitted to read the image from the original using the copying or scanning function, and executes a copy process depending on a response to the inquiry from the copyright management server 30. In this case, a radio frequency tag is embedded into the original, and outputs a radio frequency tag signal representing the identification code particular to the original (also called radio frequency tag information).

Further, the copier 10 has a unique equipment ID allotted to each copier.

The copyright management server 30 receives the identification code from the copier 10, and when the inquiry about the copy permissibility for the original is received, inquires of a copyright database 30a whether the sent original corresponding to the identification code is permitted to be copied, determines the permissibility of copying, and sends the determination to the copier 10 originating the inquiry. Further, the copyright management server 30 updates copying history information recorded in a copy history database 30b every time the copier 10 executes the copy process.

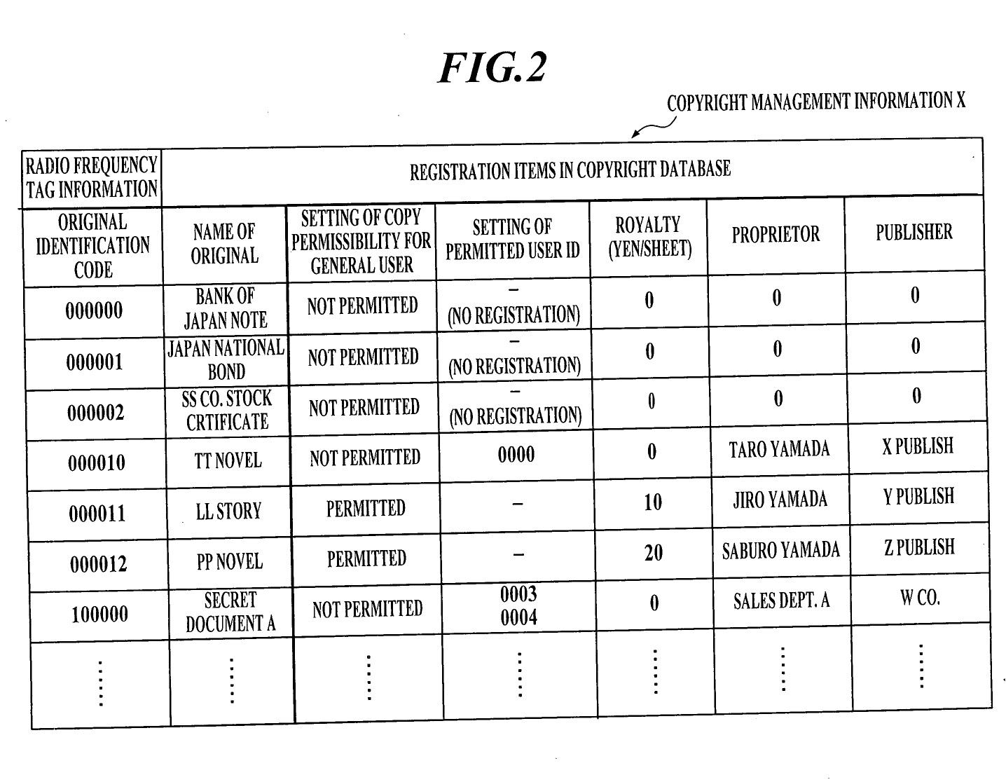

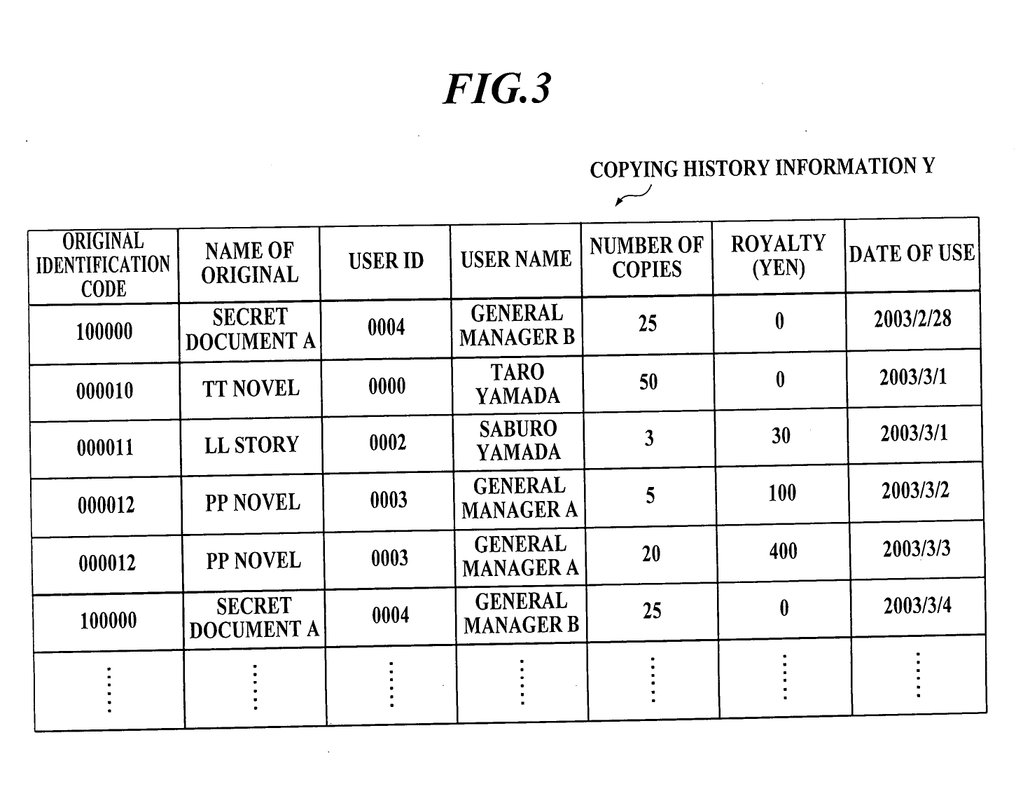

The copyright database 30a stores copyright management information (for example, refer to copyright management information X shown in FIG. 2) on the original needing the copyright management, and the copy history database 30b stores the copying history information (for example, see copying history information Y shown in FIG. 3) relating to the copy process executed by the copier 10.

The copyright management information X has such information as radio frequency tag information (identification code), name of original, setting of copy permissibility for general user, setting of permitted user ID, royalty (yen/sheet), proprietor, and publisher. The copying history information Y has such information as identification code, name of original, user ID, user name, number of copies, royalty (yen), and date of use.

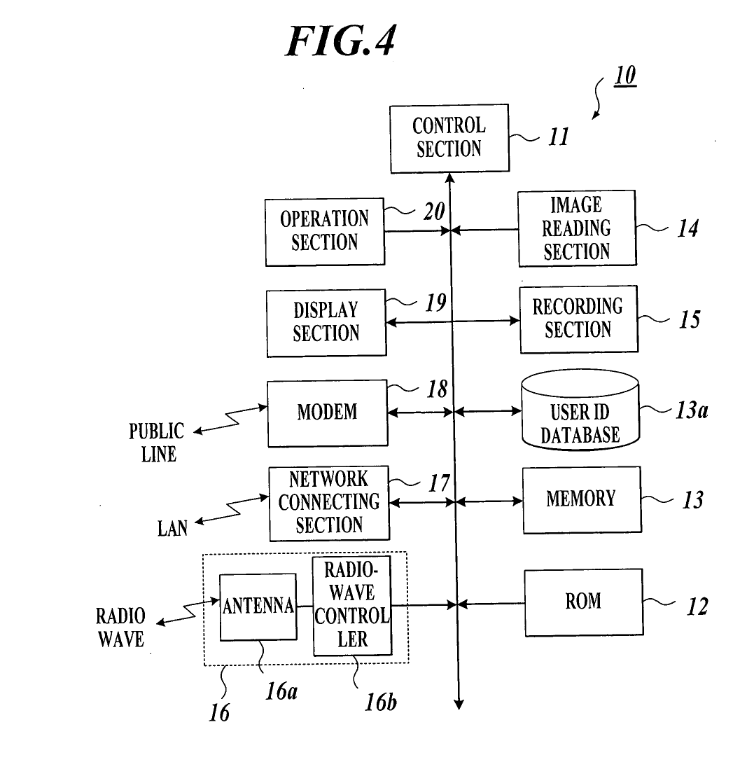

The structure of the copier 10 will be explained with reference to FIG. 4 showing the internal structure of the copier 10.

As shown in FIG. 4, the multifunction machine 10 has a control section 11, ROM 12, memory 13, image reading section 14, recording section 15, identification code obtaining section 16, network connecting section 17, modem 18, display section 19, operation section 20 and the like.

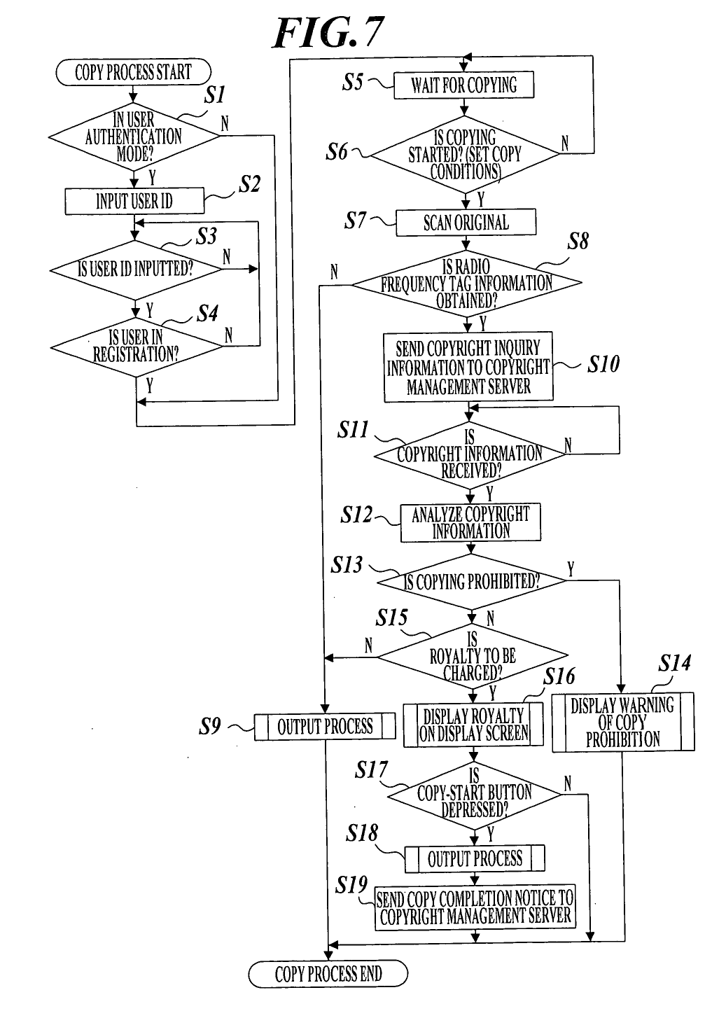

The control section 11 controls the overall copier 10 with execution of various programs stored in the ROM 12, particularly executes the copy process shown in the flow chart of FIG. 7 with execution of copy process program stored in the ROM 12.

The ROM 12 stores various programs and various data to be executed by the control section 11, particularly the copy process program for executing the copy process shown in the flow chart of FIG. 7.

The memory 13 expands and stores the above various programs in executable forms, and temporarily stores various data produced during execution of the above various programs.

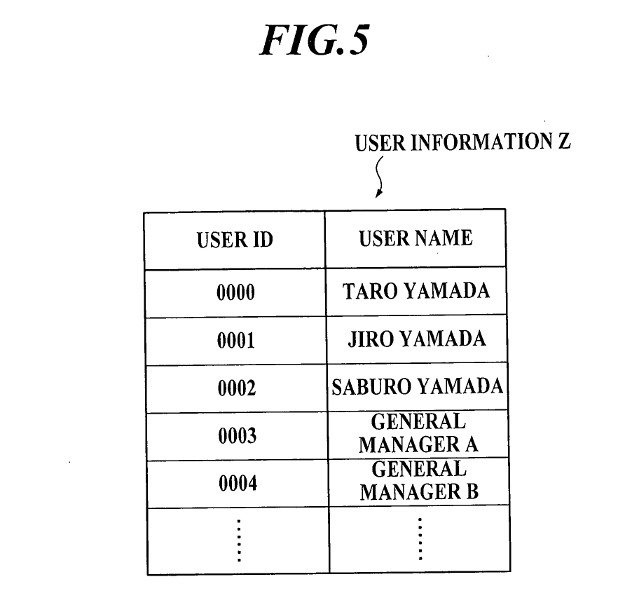

A user ID database 13a is a writable/readable memory and stores user information (for example, see user information Z shown in FIG. 5) for the user who uses the copier 10.

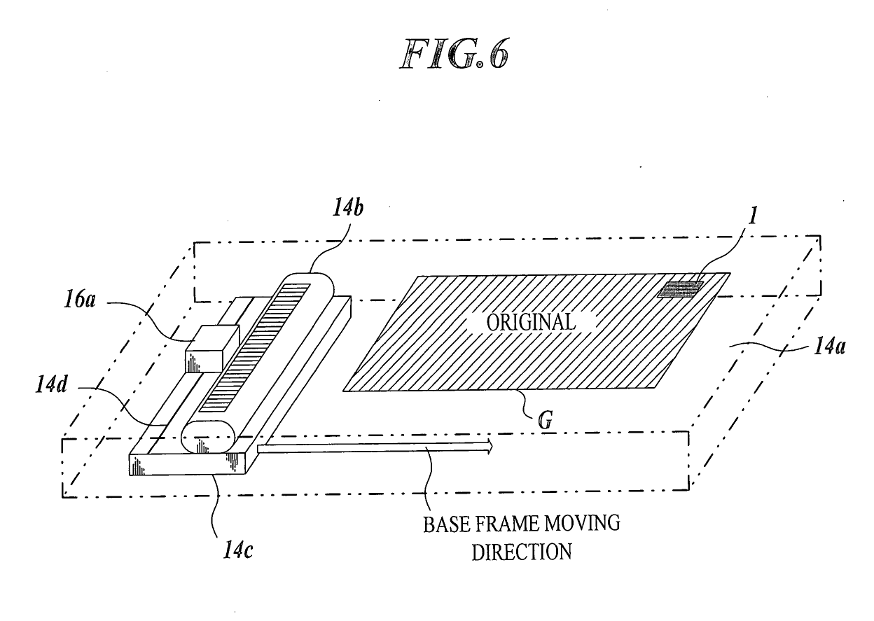

The image reading section 14, as shown in FIG. 6, has a document table 14a, an illumination lamp 14b, a lamp base frame 14c and the like, and reads an image from an original G by scanning the original G placed on the document table 14a. The lamp base frame 14c is movable in a base frame moving direction, and provided with the illumination lamp 14b for reading the image in the original G and an antenna 16a for receiving an radio frequency tag signal representing the radio frequency tag information sent from an radio frequency tag 1 embedded in the original G. The antenna 16a is movable along an antenna moving guide 14d formed on the lamp base frame 14c. When the original G is scanned by the illumination lamp 14b, the control section 11 controls a driving unit (not shown) for the lamp base frame 14c and the antenna 16a so as to move the lamp base frame 14c in the base frame moving direction with the antenna 16a reciprocated along the antenna moving guide 14d at predetermined periods.

This allows the antenna 16a to receive the radio frequency tag signal sent from the radio frequency tag 1, regardless of embedded position of the radio frequency tag 1 in the original G. Even if a sheet-through type automatic document feeding device is mounted on the document table 14a, the radio frequency tag signal can be securely received because the antenna 16a is disposed near the illumination lamp 14b.

The recording section 15 prints out the image read by the image reading section 14 on a recording medium such as paper, according to an instruction from the control section 11.

The identification code obtaining section 16 has the antenna 16a and a radio-wave controller 16b, and reads from the radio frequency tag embedded in an original an identification code (namely, radio frequency tag information) for discriminating and identifying the original.

The antenna 16a receives the radio frequency tag signal from the radio frequency tag placed on the document table 14a of the image reading section 14, and sends it to the radio-wave controller 16b. The radio-wave controller 16b obtains the radio frequency tag information with the received radio frequency tag signal demodulated, and sends the obtained radio frequency tag information to the control section 11.

The network connecting section 17 has an interface for sending and receiving data to and from external equipment through a LAN. The modem 18 has an interface for communicating data with external equipment through a public line such as a telephone line.

The display section 19 has a display device (not shown) such as an LCD (liquid Crystal Display), and displays on the display device various images sent from the control section 11.

The operation section 20 has a pointing device such as various functional keys and a touch panel for sending various command inputs to the control section 11. Meanwhile, the touch panel is affixed on the display screen included in the display section 19.

Referring back to FIG. 1, a description will be given of the outline of the process executed by the copyright management system 100.

The copier 10 sends to the copyright management server 30 the radio frequency tag information of the original to be copied, the user ID of a user operating the copier 10, the number of copies, and the equipment ID of the copier 10 (hereinafter inclusively called “copyright inquiry information”) to request for sending the copyright management information associated with the original (step A1). Meanwhile, the copyright inquiry information may further have information indicating paper size, original reading conditions, copying conditions and the like.

Upon receiving the copyright inquiry information from the copier 10, the copyright management server 30 accesses (inquires) the copyright database 30a to determine whether the radio frequency tag information (identification code) included in the copyright inquiry information is on registration in the copyright database 30a (step A2). In case of the registration, the copyright management information corresponding to the radio frequency tag information is read from the copyright database 30a (step A3).

Then, the copyright management server 30 sends the copyright management information read from the copyright database 30a to the copier 10 originating the inquiry (step A4).

Upon receiving the copyright management information from the copyright management server 30, the copier 10 displays a part of or whole contents of the copyright management information on the display section 19, and determines the permissibility of copying it based on the copyright management information (step A5).

In case copying is permitted, the copier 10 copies the original under the predetermined copying condition (for example, printing out the read image, recording the image on a recording medium as data or the like), and sends to the copyright management server 30 the radio frequency tag information of the original, the user ID of the user having operated the copier 10, user name, the number of copies, equipment ID of the copier 10 used for the copying, and information indicating the completion of copying (hereinafter inclusively called “copy completion notice information”) (step A6). Meanwhile, the copy completion notice information may further have information indicating paper size, original reading condition, copying condition and the like.

Upon receiving the copy completion notice information from the copier 10, the copyright management server 30 updates the copying history information in the copy history database 30b based on the received copy completion notice information (step A7).

When a client PC 40 or the copier 10 requests the copyright management server 30 to send the copying history information, the copyright management server 30 reads the copying history information from the copy history database 30b, and sends it to the requesting source (step A8). In this case, the user having requested the copying history information through the client PC 40 or the copier 10 sends or pays an account of royalty based on the account information included in the copying history information.

Next, a detailed description will be given of the process, which has been executed by the management system 100 as roughly described above, for the copier 10 and the copyright management server 30 respectively.

First, a copy process executed by the copier 10 will be explained with reference to FIG. 7.

The copy process first determines whether a user authentication mode is set for inputting the user ID (step S1). In case the user authentication mode is not set (step S1; No), the copy process moves to step S5, and in case the user authentication mode is set (step S1; Yes), a user ID input content is displayed on the display section 19 for urging the user to input the user ID (step S2).

Step S3 checks whether the user ID is inputted (step S3; No), and in case the user ID is inputted (step S3; Yes), the user ID database 13a is accessed to confirm whether the inputted user ID is on registration in the user ID database 13a (step S4). In case the inputted user ID is not on registration in the user ID database 13a (step S4; No), the copy process moves back to step S3 to wait for re-input of user ID, and in case the inputted user ID is on registration in the user ID database 13a (step S4; Yes), the process proceeds to step S5.

After step S4 is finished or step S1 is selected, the copy process brings the copier into a copy standby state for waiting the copier for initiation of a copy mode in which the copy function or scanner function is to be used (step S5), until the copy mode starts with the copying condition (e.g. magnification, density, paper size, number of copy-sets, etc.) set (step S6; No).

In case the copying condition is set (step S6; Yes), the copy process starts scanning the original and temporarily stores the scanned and read image into the memory 13 (step S7). At this time, the number of scanned original sheets (hereinafter “number of copies”) is counted.

Then, the copy process determines whether the radio frequency tag information is obtained from the scanned original (step S8). In case the radio frequency tag information is not obtained (step S8; No), the copy process moves to step S9 which reads out from the memory 13 the read image and outputs it (for example, printing out or recording on a recording medium as data) (step S9).

In case the radio frequency tag information is obtained at step S8 (step S8; Yes), the copyright inquiry information having the obtained radio frequency tag information is sent to the copyright management server 30 to request sending the copyright management information associated with the original (step S10).

Thereafter, the copy process checks whether the copyright management information is received from the copyright management server 30 (step S11; No, corresponding to step A4 in FIG. 1). In case the copyright management information is received (step S11; Yes), the copy process analyses the received copyright management information (step S12), and determines whether copying of the scanned original is prohibited (step S13).

In case the copying is prohibited at step S13 (step S13; Yes), the copy process moves to step S14 which displays a message on the display section 19 notifying that copying is prohibited (for example, displaying “original is prohibited to be copied”), and ends the copy process. In case the copying is not prohibited at step S13 (step S13; No), the copy process determines whether the royalty is charged on the scanned original based on the received copyright management information (step S15).

In case the royalty is free at step S15 (step S15; No), the copy process moves to step S9 where the read image is read out from the memory 13 and outputted. In case the royalty is charged at step S15 (step S15; Yes), the royalty is displayed on the display section 19 (step S16) with a message for example, “10 yen/sheet is to be charged as royalty in case you copy the original”, and the copy process determines whether a copy-start button on the operation section 20 is depressed (step S17).

In case the copy-start button is not depressed at step S17 (step S17; No), the copy process ends, and in case the copy-start button is depressed (step S17; Yes), the same output process is executed as step S9 (step S18). After the output process is finished, the copy completion notice information is produced and sent to the copyright management server 30 (step S19).

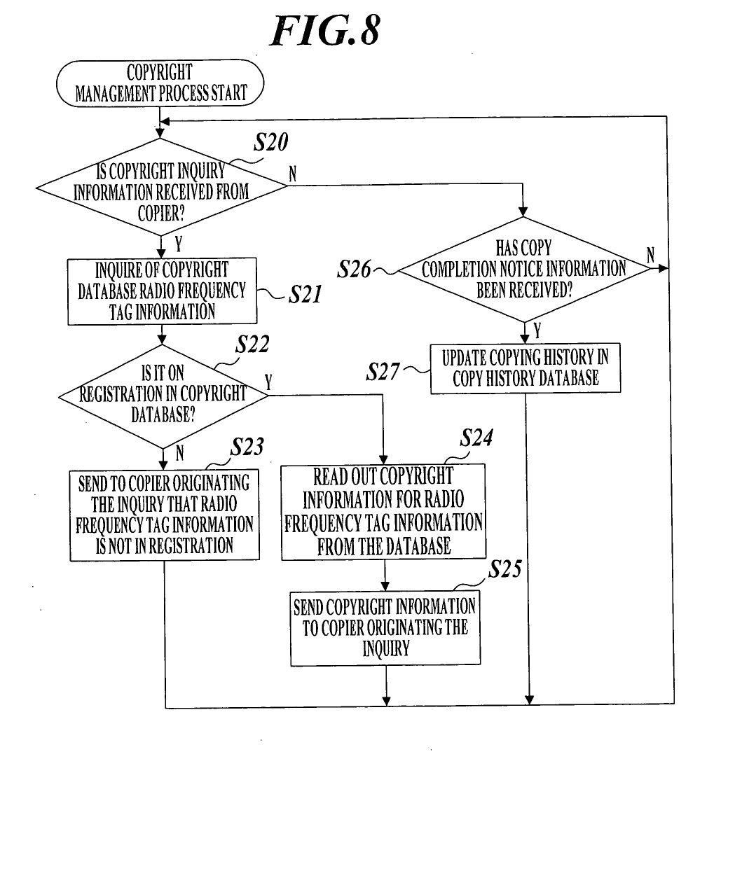

Next, a copyright management process executed in the copyright management server 30 will be explained referring to FIG. 8.

The copyright management process first determines whether the copyright inquiry information is received from the copier 10 (step S20). In case the copyright inquiry information is received (step S20; Yes), the copyright database 30a is accessed (inquired) to determine whether the radio frequency tag information (identification code) included in the received copyright inquiry information has already been registered in the copyright database 30a (step S22).

In case the radio frequency tag information is not registered in the copyright database 30a at step S22 (step S22; No), the information that the copyright management information corresponding to the radio frequency tag information has not been registered in the copyright database 30a (step S23) is sent to the copier 10 which is the sender of the copyright inquiry information. Further, in case the radio frequency tag information is registered in the copyright database 30a at step S22 (step S22; Yes), the copyright management information corresponding to the radio frequency tag is read out from the copyright database 30a (step S24), and sends the read copyright management information to the copier 10 originating the inquiry (step S25).

Referring back to step S20, in case the copyright inquiry information is not received from the copier 10 (step S20; No), the copyright management process determines whether the copy completion notice information is received from the copier 10 (step S26).

In case the copy completion notice information is not received from the copier 10 (step S26; No), the copyright management process moves back to step S20, and in case the copy completion notice information is received from the copier 10 (step S26; Yes), the copyright management process updates the copying history information recorded in the copy history database 30b based on the received copy completion notice information (for example, recording the copying history information in the copy history database 30b based on the copy completion notice information)(step S27).

Further, for the copying history information recorded in the copy history database 30b, the royalty is added up at predetermined periods (for example, every one month) for each identification code or each user ID. The added value is stored in the memory (not shown) built in the copyright management server 30. Further, responding to a request for sending (for example, the request originated by the client PC 40), the added value of the royalty is sent to the requesting source, whereby the royalty can be collected securely and smoothly.

As described above, the copier 10 scans an original to be copied, reads from the original the radio frequency tag information representing the identification code, and sends the read copyright inquiry information (and the radio frequency tag information) to the copyright management server 30 to ask whether copying of the original is permitted. The copyright management server 30 has for each radio frequency tag (identification code) the copyright management information having the information such as copy permissibility and a royalty. When the copyright inquiry information is received from the copier 10, the copyright management information corresponding to the radio frequency tag information included in the copyright inquiry information is read out from the copyright database 30a, and sends it back to the copier 10. Subsequently, when the copyright management information is received from the copyright management server 30, the copier 10 executes the copy process based on the content of the received copyright management information.

Accordingly, based on the radio frequency tag information embedded into the original to be copied, it is easily determined whether the original is permitted to be copied, how much royalty is to be charged when copying is permitted and the like. Therefore, in case the original is not permitted to be copied, it is not copied, and in case the original is permitted to be copied in exchange for payment of the royalty, the royalty can be securely collected, leading to secure protection of copyright.

Further, since the copyright management server 30 collectively manages the copyright management information, setting of copy permissibility, royalty and the like can be changed easily and rapidly.

As for a secret document, an important document and the like produced in a company, the copy permissibility thereof can be set for each user (for example, employee) to thereby achieve flexible and precise copyright protection (including secrecy, particular image and the like).

Further, even in case either of copying function or scanning function is used, the read image can be printed out or be recorded in a recording medium as data. Even both cases can achieve secure copyright protection, realizing high versatility.

The present invention is not limited to the above-described one embodiment of copyright management system according to the present invention, and detailed structures and operations of the copyright management system 100 may be changed within the scope of the invention.

For instance, in the copyright management system 100, although the copier 10 obtains the radio frequency tag information from the radio frequency tag embedded into an original, it does not limit the present invention and the copier 10 may obtain the same information as the radio frequency tag information from a non-contact IC chip embedded into an original.

Although the case that the original image on publication is copied was described, the above copyright management is applicable to the data image of program in addition to the original of publication.

The entire disclosure of Japanese Patent Applications No. Tokugan 2003-193618 filed on Jul. 8, 2003 is incorporated herein by reference in its entirety.

1. An copyright management system comprising: a copier for copying an original and/or data, a copyright database for storing copyright management information having information indicating a permissibility of copying the original and/or data, and a copyright management server for sending the copyright management information to a requesting source in response to an inputted sending request, the copier, the copyright database and the copyright management server being connected to each other through a network,
wherein the copier comprises an identification code obtaining section for obtaining an identification code for identifying the original and/or data from a radio frequency tag embedded into the original and/or data, and a control section for sending the obtained identification code to the copyright management server, requesting the copyright management server to send the copyright management information associated with the original and/or data of the identification code, and determining the permissibility of copying the original and/or data of the identification code included in the copyright management information based on the copyright management information sent from the copyright management server in response to the sending request, and
wherein when the identification code is received from the copier, the copyright management server obtains the copyright management information associated with the original and/or data of the received identification code from the copyright database, and sends the obtained copyright management information to the copier.

2. The system of claim 1, wherein the copyright management information comprises information indicating a royalty for each original and/or data to be paid at each time of copying.

3. The system of claim 1, wherein the copier comprises a display section for displaying a part of or whole copyright management information received from the copyright management server.

4. The system of claim 1, wherein a copy history database for storing copying history information representing a copying history for each original and/or data is connected to the network,
when copying is performed, the control section sends a copy completion notice information having information of finishing the copying and the identification code of a copied original and/or data to the copyright management server, and the copyright management server updates the copying history information for the original and/or data of the identification code included in the sent copy completion notice information out of the copying history information recorded in the copy history database based on the copying history information.

5. The system of claim 4, wherein in case a user ID for identifying an operator of a copy operation is inputted at a time of the copying, the control section sends the inputted user ID and the copy completion notice information to the copyright management server, and the copyright management server makes the copying history information for the original and/or data of the identification code included in the sent copy completion notice information associated with the sent user ID, out of the copying history information recorded in the copy history database, and updates the copying history information based on the copying history information.

6. The system of claim 5, wherein the copyright management server adds up the royalty at predetermined periods for each identification code or each user ID in the copying history information recorded in the copy history database, and sends an added-up value of the royalty to the requesting source in response to the inputted sending request.
